(19) United States
(12) Patent Application Publication
(10) Pub. No.: US 2013/0104089 A1
(43) Pub. Date: Apr. 25, 2013

(54) GESTURE-BASED METHODS FOR INTERACTING WITH INSTANT MESSAGING AND EVENT-BASED COMMUNICATION APPLICATIONS

(71) Applicants: Eleanor RIEFFEL, Redwood City, CA (US); Jacob Biehl, San Jose, CA (US); Althea Turner, Menlo Park, CA (US)

(72) Inventors: Eleanor RIEFFEL, Redwood City, CA (US); Jacob Biehl, San Jose, CA (US); Althea Turner, Menlo Park, CA (US)

(73) Assignee: FUJI XEROX CO., LTD., Tokyo (JP)

(21) Appl. No.: 13/277,961

(22) Filed: Oct. 20, 2011

(51) Int. Cl. G06F 3/033; G06F 15/16

(52) U.S. Cl. 715/863

(57) ABSTRACT

Gesture-based methods of managing communications of a user participating in communication sessions permit the user to easily manage the communications sessions by defining gestures, defining a meaning of the gesture, and outputting the meaning of the gesture to a communication session when the gesture is detected. The gestures may be contextually dependent, such that a single gesture may generate different output, and may be unconventional to eliminate confusion during gesturing during the communication sessions, and thereby the communications sessions may be more effectively managed.

### BACKGROUND

1. Field

The present disclosure relates to gesture recognition, and more particularly to gesture-based methods for managing communications of a user participating in an electronic communication session.

2. Description of Related Art

Methods of communicating between users include real time communication, such as in person face-to-face conversations, telephone conversations, instant messaging (IM) conversations, video conferencing, and communication within virtual worlds. Frequently, a person may participate in multiple different types of conversations, taking place in one or more modes. Most electronic messaging clients include the capability for a user to simultaneously participate in multiple communications sessions between various parties.

In general, people are skilled at negotiating between multiple in-person face-to-face conversations in which all parties are physically present, adjusting for interruptions and transitioning between the different face-to-face conversations. However, users of electronic messaging applications may not be adept at managing multiple conversations with other users who are not physically present. For example, if a user is involved in an ongoing electronic communication session, it may be awkward for the user to continue typing at a computer when a visitor arrives. Similarly, it may be considered rude to stop responding in an ongoing electronic conversation without providing to the other user participating in the electronic conversation a reason for ceasing participation.

Similarly, the situation frequently occurs when a user who is already participating in a communication session begins to participate in additional communication sessions. This provides a dilemma for the user as to how the communication sessions should be managed that has not yet been addressed by current communication tools or social etiquette.

### BRIEF SUMMARY

The present application provides improved methods for managing conversations across multiple modes using gestures to manage the conversations.

According to an aspect of the embodiments, a method of processing a gesture may include detecting a gesture of a user; determining a first message associated with the gesture and a first communication session, based on the gesture; determining a second message associated with the gesture and a second communication session, based on the gesture; and outputting the first message to the first communication session and outputting the second message to the second communication session.

According to an aspect of the embodiments, a method of processing a gesture may include detecting a gesture of a user; determining a first message associated with the gesture and a second user, based on the gesture; determining a second message associated with the gesture and a third user, based on the gesture; and outputting the first message to a first communication session between the user and the second user and outputting the second message to a second communication session between the user and the third user.

According to an aspect of the embodiments, a method of processing a gesture may include defining, by a user, an unconventional gesture; associating the unconventional gesture with a message; detecting the unconventional gesture of the user; and outputting the message associated with the unconventional gesture to a communication session between the user and a second user, in response to detecting the unconventional gesture.

### BRIEF DESCRIPTION OF THE DRAWINGS

The above and other aspects of the embodiments will become better understood with regard to the following description of the embodiments given in conjunction with the accompanying drawings, in which:

FIG. 1 is a block diagram of a system to which the embodiments may be applied.

FIG. 2 is a diagram of a system for managing a communication session using gestures, according to an embodiment.

FIG. 3 illustrates an additional system for managing a communication session using gestures, according to an embodiment.

FIGS. 4A-D illustrate examples of gestures detected by the system for managing a communication session, according to an embodiment.

FIG. 5 illustrates a gesture dictionary, according to an embodiment.

FIG. 6 illustrates a method of managing a communication session using gesture processing, according to an embodiment.

### DETAILED DESCRIPTION

Specific embodiments will be covered by the detailed description and drawings.

The description of the embodiments is presented for purposes of illustration and description, but is not intended to be exhaustive or limited to the forms disclosed. Many modifications and variations will be apparent to those of ordinary skill in the art without departing from the scope and spirit of the disclosure. The embodiments are selected and described to best explain the principles of the disclosure, their practical application, and to enable others of ordinary skill in the art to understand the disclosure and various modifications suited to the particular use contemplated.

Aspects of the embodiments may be a system, method or computer program embodied on a computer-readable medium having computer readable program code embodied thereon. Accordingly, aspects of the embodiments may take the form of an entirely hardware embodiment, an entirely software embodiment, or an embodiment combining software and hardware aspects.

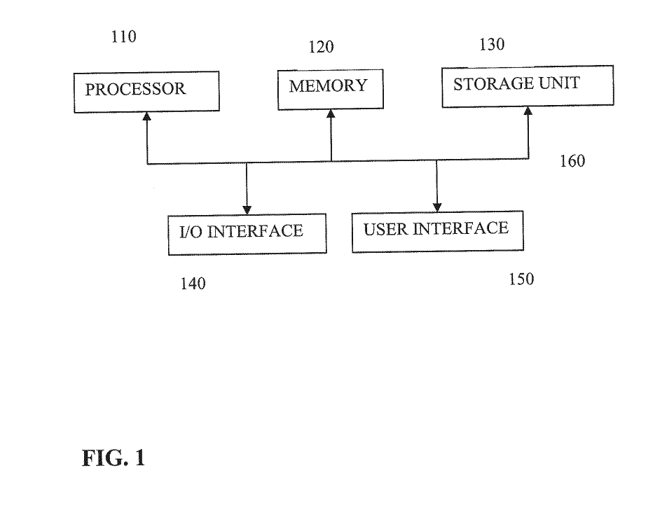

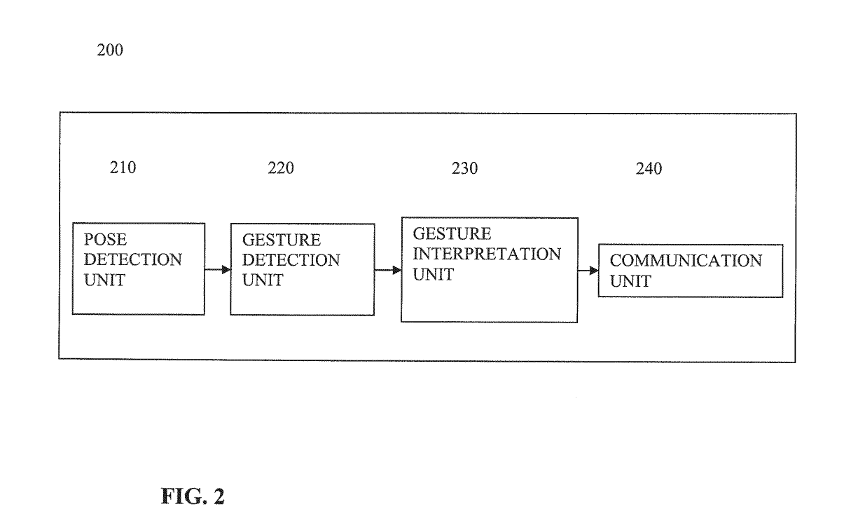

FIG. 1 is a block diagram illustrating a system to which the embodiments may be applied.

Referring to FIG. 1, the system 100 may be a general purpose computer, special purpose computer, personal computer, server, tablet, or the like. The system 100 may include a processor 110, a memory 120, a storage unit 130, an I/O interface 140, a user interface 150, and a bus 160. The processor 110 may be a central processing unit (CPU) or microcontroller that controls the operation of the system 100 by transmitting control signals and/or data over the bus 160 that communicably connects the elements 110 to 150 of the system 100 together. The bus 160 may be a control bus, a data bus, or the like. The processor 110 may be provided with instructions for implementing and controlling the operations of the system 100, for example, in the form of computer readable codes. The computer readable codes may be stored in the memory 120 or the storage unit 130. Alternatively, the computer readable codes may be received through the I/O interface 140 or the user interface 150.

As discussed above, the memory 120 may include a RAM, a ROM, an EPROM, or Flash memory, or the like. As also discussed above, the storage unit 130 may include a hard disk drive (HDD), solid state drive, or the like. The storage unit 130 may store an operating system (OS) and application programs to be loaded into the memory 120 for execution by the processor 110. The I/O interface 140 performs data exchange between the system and other external devices, such as other systems or peripheral devices, directly or over a network, for example a LAN, WAN, or the Internet. The I/O interface 140 may include a universal serial bus (USB) port, a network interface card (NIC), Institution of Electronics and Electrical Engineers (IEEE) 1394 port, and the like. The user interface 150 receives input of a user and provides output to the user. The user interface 150 may include a mouse, keyboard, touchscreen, or other input device for receiving the user's input. The user interface 150 may also include a display, such as a monitor or liquid crystal display (LCD), speakers, and the like for providing output to the user.

The flowchart and block diagrams in the Figures illustrate the architecture, functionality, and operation of implementations of systems, methods and computer program products according to the various embodiments. In this regard, each block in the flowchart or block diagrams may represent a module, segment, or portion of code, which includes one or more executable instructions for implementing the described functions. In alternative implementations, the functions noted in the block may occur out of the order noted in the Figures, and combinations of blocks in the diagrams and/or flowcharts, may be implemented by special purpose hardware-based systems that perform the specified functions.

FIG. 2 illustrates a system for managing a communication session using gestures.

The system 200 may include a pose detection unit 210, a gesture detection unit 220, a gesture interpretation unit 230, and a communication unit 240. The system 200 may be implemented through combinations of hardware, including a processor and memory, and software executed by the hardware for interpreting inputs and providing outputs through various interfaces.

The pose detection unit 210 detects a pose of a user. The pose may include a position of one or more body parts of the user. Accordingly, the pose detection unit 210 may detect a position of a finger of the user, a position of a hand of the user, or a position of the entire user, for example. The pose detection unit 210 may be a sensor or video camera that, continually or systematically in response to an input such as detected movement of the user, tracks a position of the user, positions of the body parts of the user, and orientations of the body parts.

To detect the pose, the pose detection unit 210 may detect coordinates of body parts with respect to a point of reference or with respect to a position of at least one other body part. Accordingly, the pose detection unit 210 may employ joint angles or confidence estimates as the detected pose of the user.

The pose detected by the pose detection unit 210 may be a complex pose that includes any combination of positions or orientations of body parts of the user, with respect to the point of reference or other body parts. For example, the complex pose may include a position of a right hand of the user and a position of the left hand of the user. The pose detection unit 210 outputs the detected pose as pose data to the gesture detection unit 220.

The pose detection unit 210 may also detect movement of the user as the pose. Accordingly, the pose detection unit 210 may detect translation of one or more body parts of the user from a first position to a second position. The translation of the body part may be translation from a first position to a second position, relative to the point of reference. Alternatively, the translation may be with respect to the position of at least one other body part.

The complex pose of combinations of positions or orientations of plural body parts of the user may include one or more translations of the plural body parts. In this regard, the complex pose may include one or more positions of the plural body parts, one or more translations of the plural body parts, and any combination of positions and translations.

The gesture detection unit 220 receives the pose data output by the pose detection unit 210. In response to receiving the pose data output by the pose detection unit 210, the gesture detection unit determines whether the pose data of the user includes gesture data corresponding to a gesture of the user.

If the pose data includes data indicating positions of body parts of the user, the gesture detection unit 220 analyzes the pose data to determine whether a position or set of positions of a body part or multiple body parts at one point in time or for a time period among the pose data corresponds to a predetermined gesture. For example, the gesture detection unit 220 may determine whether a pose of a hand has been held in a stable position for a period of time or whether the position of the hand changes from a first position to a second position during a period of time. The gesture detection unit 220 may access a database of gesture data to determine whether gesture data corresponding to a gesture exists within the pose data. If the gesture data corresponds to a complex gesture, the gesture detection unit 220 may analyze combinations of gesture data corresponding to different positions of body parts to determine whether a complex gesture exists within the pose data.

As a result of determining that the gesture data exists, the gesture detection unit 220 outputs the determined gesture data to the gesture interpretation unit 230. In this regard, the gesture data output by the gesture detection unit 220 may be a subset of the pose data output by the pose detection unit 210. Here, the subset of data may be only those data determined to correspond to one or more predetermined gestures. Alternatively, if the gesture detection unit 220 determines that the entire pose data corresponds to the predetermined gesture, the gesture detection unit 220 may output the entire pose data as the gesture data to the gesture interpretation unit 230.

The gesture interpretation unit 230 receives the gesture data output by the gesture detection unit 220. In response to receiving the gesture data output by the gesture detection unit 220, the gesture interpretation unit 230 interprets the gesture. In this regard, the gesture data representing a physical gesture of the user is translated into an electronic command, one or more messages, or a combination of one or more commands and one or more messages.

The gesture interpretation unit 230 may access a database of gestures and their associated meanings. In this regard, the database of gestures may be conceptualized as a gesture dictionary. Each gesture stored within the database of gestures is associated with at least one meaning or definition.

To determine a meaning of the gesture, the gesture interpretation unit 230 may relate the gesture and additional data to provide context for selecting an appropriate meaning of the gesture from among multiple meanings. Accordingly, based on the data from the additional sources, the meaning of the gesture may be appropriately determined.

As a result of interpreting the gesture, the gesture interpretation unit 230 outputs the determined interpretation to the communication unit 240.

The communication unit 240 receives the interpretation of the gesture output by the gesture interpretation unit 230. In response to receiving the interpretation of the gesture output by the gesture interpretation unit 230, the communication unit 240 outputs the interpretation to one or more applications.

As discussed above, the interpretation may be one or more commands, one or more messages, or a combination of commands and messages. If the interpretation includes a message, the interpretation may instruct the application to output the message. Commands may be one or more instructions that control an application to perform a function. The function may be any application-independent function performed by any application, such as exiting from the application or opening a new instance of the application. The function may also be an application-dependent function, specific to the application. In the context of an instant messaging application, the command may control the application to initiate a communication session (e.g., video conference, chat session, etc.) with another user, enable or disable desktop sharing, or perform a function of setting or changing a status message that indicates a status of a user. For example, the status message may indicate that the user is away from a computer, unavailable, or available. The status message may be determined according to context data from external sources, such a calendar. Accordingly, the unavailable status message may indicate a reason for the unavailability, such as a meeting in progress, as determined by reference to a meeting scheduled on the calendar. Alternately, the status message may indicate that the conversation between users is off the record or confidential.

The message may be a string of characters as a text message, an audio message corresponding to a string of characters, a video message, or any combination of text, audio, and video.

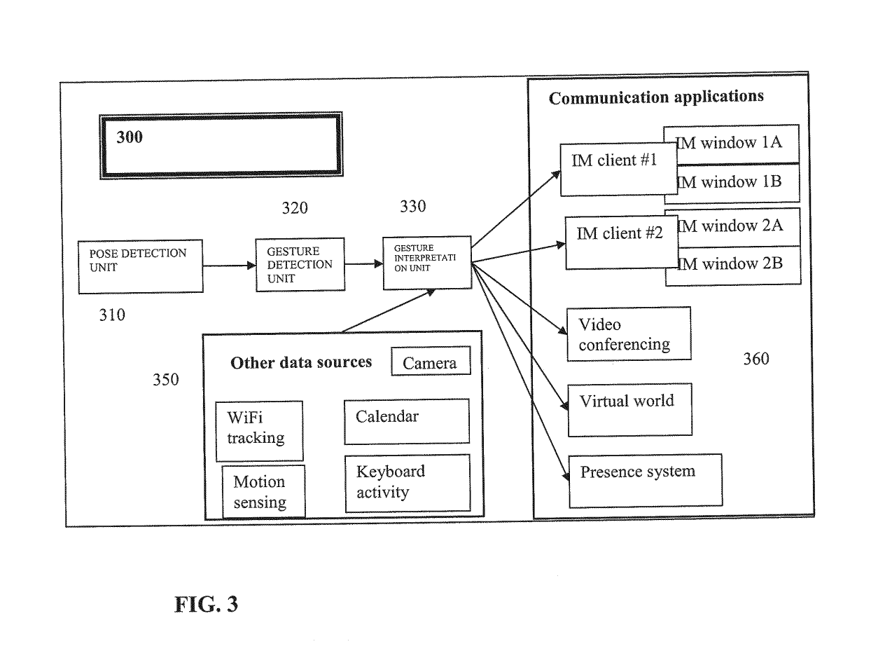

FIG. 3 illustrates an additional system for managing a communication session using gestures.

The system 300 illustrated in FIG. 3 is similar to the system 200 illustrated in FIG. 2, and thus description of like elements 310, 320, and 330, which perform similar functions to elements 210, 220, and 230 of FIG. 2, will be omitted for the sake of clarity.

The system 300 includes additional data sources 350, from which additional data for managing an electronic communication session may be obtained. The additional sources of data may include, for example, WiFi tracking devices, a calendar, a keyboard, a fire alarm system, and other motion sensing and camera devices.

In addition to the gesture data output by the gesture detection unit 320, the gesture interpretation unit may receive input from the additional data sources 350. Based on gesture data received from the gesture detection unit 320 and the additional data received from the additional data sources 350, the gesture interpretation unit 330 may determine a meaning of gesture from among plural different meanings Accordingly, the additional data detected by the additional data sources 350 and provided to the gesture interpretation unit 330 may provide context for the determination of the meaning of the detected gesture.

The interpretation of the gesture by the gesture interpretation unit 330 may be output by a communication unit (not shown) to various communication applications 360. The communication applications 360 may be, for example, one or more instant messaging clients, a video conferencing application, a virtual world application such as a gaming application, or a presence system.

The output to the communications applications 360 may be context dependent. A single gesture that is detected may be contextually related with each application (IM client #1 and IM client #2) such that a first message associated with the gesture and a first application (IM client #1) is output to the first application (IM client #1), while a second message associated with the gesture and a second application (IM client #2) is output to the second application (IM client #2).

Similarly, the output to the communications applications may be contextually related with identities of other users involved in the communication. A single gesture that is detected may be contextually related by user, such that a first message associated with a gesture and a first user in a first session (IM window 1A) is output to the first session (IM window 1A), while a second message associated with the gesture and a second user in a second session (IM window 1B) is output to the second session (IM window 1B).

Of course, all combination of users and applications may be associated with a gesture, such that each combination of user and application may be associated with a different meaning for a single gesture.

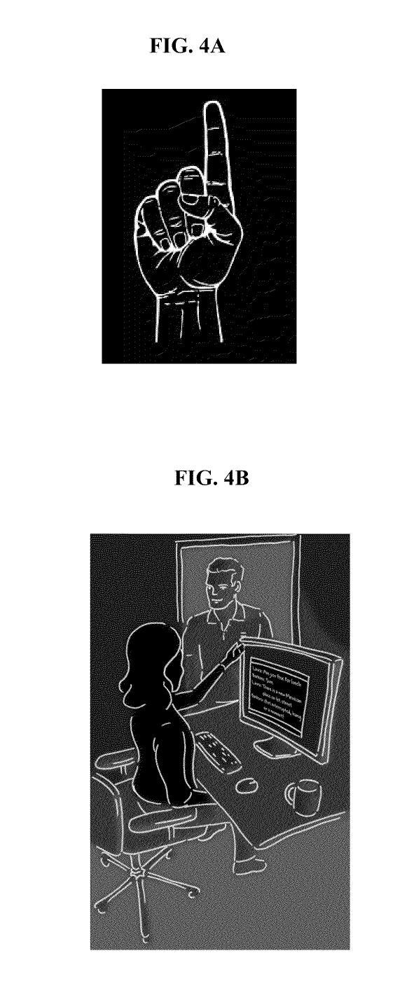

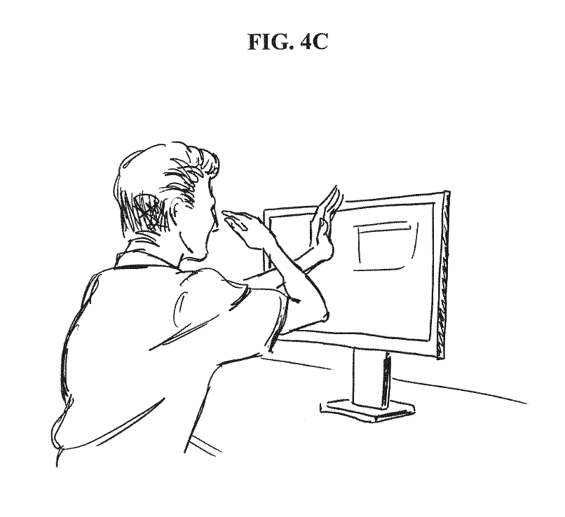

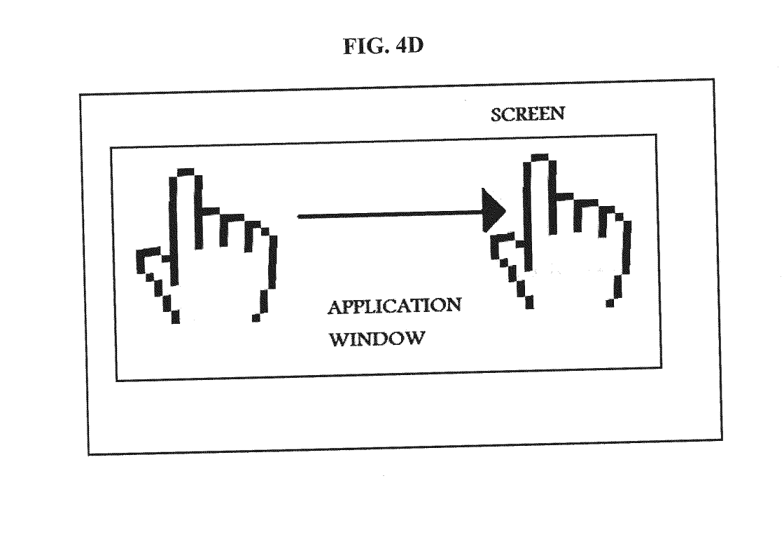

FIGS. 4A-D illustrate examples of gestures detected by the system for managing a communication session.

As discussed above with respect to the gesture detection unit 220 in the system 200 of FIG. 2, pose data may be analyzed to detect the gestures.

As illustrated in FIG. 4A, from a point of reference, for example the sensor or video camera capturing the gesture, the gesture may be a user extending only the index finger. The skilled artisan will understand that the gesture illustrated in FIG. 4A is merely exemplary, and any combination of fingers and positioning of the fingers could be used as the gesture.

As also discussed above with respect to the gesture detection unit 220 in the system 200 of FIG. 2, pose data may be analyzed to detect complex gestures.

The complex gesture may be detection of the position of the left hand in combination with the position of the right hand. Similarly, the complex gesture may be the detection of the movement of the hands together towards an ending position or the movement of hands away from each other from a starting position.

FIG. 4B illustrates an alternate gesture that may be detected, by reference to a position of an object as the point of reference. As illustrated in FIG. 4B, the gesture may be the touch of a finger of the user at position on a monitor. In FIG. 4B, the position is the top left corner of the monitor, but any position relative to the monitor may be used.

FIG. 4C illustrates an alternate gesture, in which both of the user's arms are crossed. Accordingly, the gesture illustrated in FIG. 4C may be detected with respect to the positioning of each arm with respect to the other arm.

FIG. 4D illustrates a gesture in which the motion of a user's finger across an application window displayed on a computer screen is detected as a gesture. Accordingly, detection of the gesture may be with reference to the position of the displayed application window. The gesture may be detected based on the motion of the finger between selected positions of the application window, such as a top left corner and a top right corner, or based any left to right motion within the application window.

The gestures illustrated in FIGS. 4A-D are merely exemplary. A user of the gesture system may define any gesture and associate the gesture with any application command.

Specifically, a user may define an unconventional gesture and associate a message with the unconventional gesture. Preferably, the unconventional gesture is a gesture unrecognized by another user with whom the current user communicates so that the other user does not interpret the unconventional gesture, for managing another conversation with a third user, as having any particular meaning to avoid confusion.

As such, the unconventional gesture is preferably unassociated with communication between users, in particular nonverbal communication between users. Accordingly, detection of the unconventional gesture for controlling a first communication session between a first user and a second user does not impact a second communication session between the first user and a third user. As illustrated in FIG. 4B, the unconventional gesture may be the touch of a finger of the user to a corner of a monitor, thereby managing an electronic communication session between the user and a remote user, while the user and a local user additionally communicate face to face.

Similarly, because a user may employ many gestures during communication, the unconventional gesture is preferably not a gesture used during communication. For example, as illustrated in FIG. 4A, such a gesture is commonly used to indicate a need for a pause, and thus assigning a message to such a gesture might output the associated message to a communication session when no output was intended by the user.

The unconventional gesture may include a class of simple gestures, when touching a specific location, for example: a user's hand pauses in a specific region of space for at least a minimum amount of time; the user's hand pauses in one region, and then pauses in another region shortly thereafter; or the user's hand is held close to a surface of an object for a period of time.

Alternatively, the unconventional gesture may be with respect to the screen on which the communication applications are displayed, or may be with respect to a surface representing one or more communication applications displayed on a monitor.

As discussed above, the unconventional gesture may be a complex gesture, for example: both hands of a user held close to a surface of an object; the user's hand is held close to a surface of an object with the user's body turned away; at least one swipe across a screen from left to right (as illustrated in FIG. 4D), right to left, top to bottom, bottom to top, or diagonal; or additionally requiring a pause at a beginning and end of stroke, to ensure the gesture was intended for communication; multiple fast swipes, as in an erasing or cleaning motion; crossing arms and holding position (as illustrated in FIG. 4C); or raising a hand above the user's head and holding the position for a period of time.

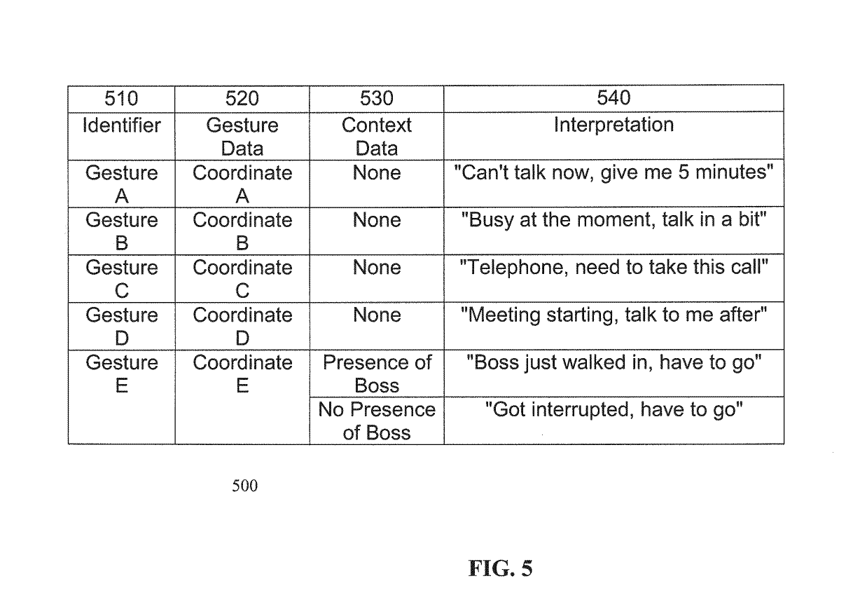

FIG. 5 illustrates a gesture dictionary, according to an embodiment.

As discussed above with respect to the gesture interpretation unit 230 in the system 200 of FIG. 2, gestures may be interpreted to output commands or messages corresponding to the gesture.

FIG. 5 illustrates a gesture dictionary. The gesture dictionary 500 relates gesture data extracted from the pose data to messages or commands to be output to an application.

Each entry to the gesture dictionary 500 may include an identifier 510, gesture data 520, context data 530 that is used to select an appropriate interpretation of the gesture, and the interpretation of the gesture 540.

The identifier 510 is a generic identifier that uniquely identifies each gesture entry in the gesture dictionary 500. The identifier may be any combination of numbers or text, and may be used as an index of the gesture dictionary 500.

The gesture data 520 is data that represents the physical movements of the user. As previously discussed, the data may be coordinate data that identifies a body part and a position of a body part of the user with respect to a reference point. The gesture data 520 may also include timing information that indicates a period of time over which the gesture may be detected. For example, the timing information may be a period of time during which the user must maintain the position of the body part to constitute the gesture. Alternatively, the timing may indicate a period of time during which movement of a body part is detected from a first position of the body part to a second position of the body part.

The context data 530 may be a non-gesture that is detected in combination with the gesture. For example, the context data 530 may indicate that an event has occurred. In Gesture E of gesture dictionary 500, corresponding to the gesture illustrated in FIG. 4B, the context data 530 may indicate that the user's supervisor has entered the user's office. Accordingly, upon detection of the user touching a top left corner of the monitor, the message “Boss walked in, have to go” may be determined. On the other hand, if the external event is not detected, such that the context data not applied to determining the meaning of the gesture, the alternate message “Got interrupted, have to go” may be determined. Accordingly, the context data 530 may provide a more detailed message associated with the gesture based on additional factors.

The context data 530 is not limited to the above described example. Other data sources may be used to include information about the type of interruption. For example, the tracking system could detect if a person, or multiple people, stopped by to talk face-to-face. The tracking system, or data directly from a phone system, could determine if the person took a phone call. When this information is available and the “Got interrupted” gesture is performed, the system could send a more specific message according to the user's preferences, such as “people just came by” or “I got a phone call,” instead.

Similarly, calendar information may indicate a scheduled meeting and identities of the participants so that, if the interruption occurs at the start of a scheduled meeting at the person's office, the gesture meaning can incorporate that information into the message, such as the start date or time of the meeting, an end date or time of the meeting, or participants of the meeting.

The type of information may depend on the user's preferences, as well as the person with whom the user is chatting, so different conversation participants may receive more or less informative messages depending on the user's settings. For example, different information from other sources may be added to a message, such as names from a calendar entry or names associated with tracked cell phones. Users can place symbols in a message associated with a gesture that tell the system to fill in this information when available from the data sources.

As discussed above, the interpretation 540 of the gesture may be defined by the user, or predefined. Given a set of gestures, users can assign their own meanings to the gestures. In some cases, a user may want to change the wording to match her personality while keeping the same meaning, while in other cases the user may want to assign an entirely new meaning to a gesture.

In order to associate a user's own text with a gesture, the user enters a gesture association mode and performs the gesture, or performs the gesture along with another signal that indicates that the user would like to change the meaning associated with this gesture. The user may interact with a GUI, for example, to enter and exit gesture association mode, or perform a gesture to enter and exit the mode. Alternatively, the user may press a button, for example on a mobile device, while performing the gesture, or perform a second gesture at the same time as a first gesture. For a set of gestures performed with one hand, a user holding the other hand over her head could indicate the user would like to change the meaning associated with the gesture. In any of these cases, when the gesture is performed, a GUI window appears in which the user can enter the text the user wishes to associate with this gesture. Alternatively, the gestures could be named, and the text association changed simply by pulling up a GUI showing the name and associated text, and providing a means for the user to change the text.

As also discussed above, the interpretation 540 of the gesture may be to output an application command. In the context of an instant messaging communication program, for example, a command to exit a chat session may be that the arms of the user are crossed in front of the user's face, a command to toggle audio within the instant messaging communication program may be to touch both of the user's ears, a command to toggle video within the instant messaging communication program may be to touch both of the user's eyes, and a command to close all confidential chats may be to touch a top of the user's head with both hands.

Similarly, the user may associate gestures with additional context data. In this regard, the gesture may have one or more interpretations, depending upon the context in which the gesture is detected. To support different messages sent to different people or clients when a single gesture is performed, the GUI can show the names of all people or clients, and the user can select the person, client, or group of persons or clients for which the text applies. The user can then repeat the gesture association process for that gesture, select a different group of people, and enter a different text. Therefore, when the gesture is performed outside of gesture association mode, a first text may be sent to one group of people, while a second text will be sent to another group.

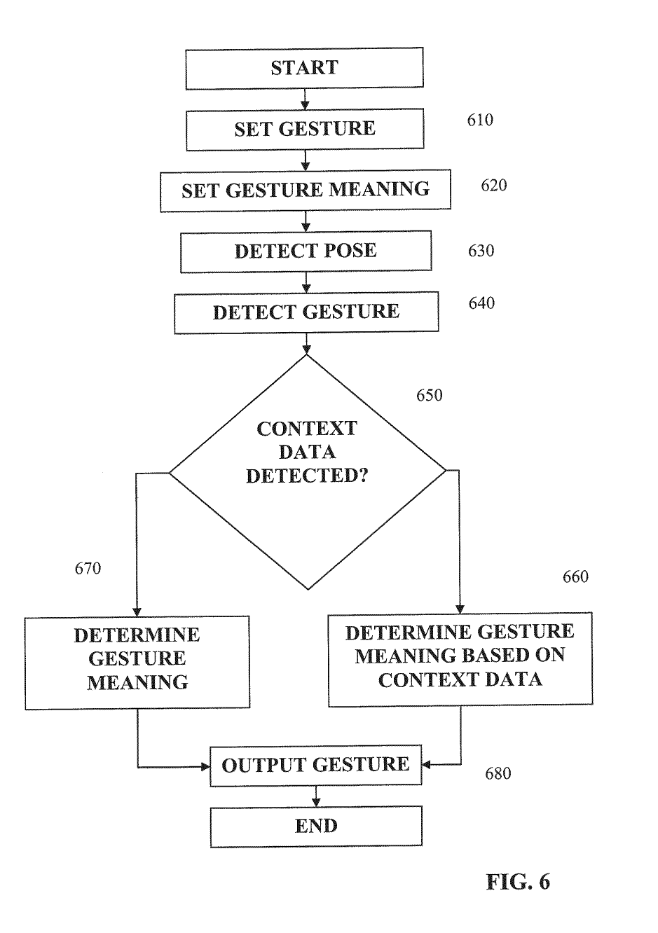

FIG. 6 illustrates a method of managing a communication session using gesture processing, according to an embodiment.

In step 610, a gesture of a user is set. As discussed above, the gesture of the user may be predefined. Alternatively, the user may set the gesture by entering a gesturing mode in which the gesture of the user is detected by a gesture processing system. The gesturing mode may be in the form of a graphical user interface (GUI) controlled by the user to capture the gesture.

In step 620, a meaning of the gesture is set. As discussed above, the meaning of the gesture may be predefined. Alternatively, the user may set the meaning of the gesture in the gesturing mode in which the meaning of the gesture is entered through the GUI. The meaning of the gesture may be stored in a gesture dictionary.

The gesture may include plural meanings, with each of the meanings associated with the gesture and context data obtained from an additional source. Each of the meanings may be associated with the context data in the gesture dictionary. Accordingly, based on the detected gesture and the detected context data, different meanings of the gesture may be set.

In step 630, a pose of a user is detected. The pose of the user may be detected by a sensor or camera that detects or tracks a position of the user.

In step 640, a gesture of the user is detected based on the pose detected in step 630, and the gesture is interpreted. The gesture of the user is interpreted with respect to a gesture dictionary. For example, it may be determined that the user has made a gesture that indicates the user is interrupted. Generally, the meaning of this gesture may be determined to be the message “I got interrupted.” Using the gesture dictionary, it may be determined that there exists multiple meanings associated with the gesture: the default message “I got interrupted,” the message “Visitors stopped by,” and the message “<names> stopped by.”

In step 650, it is determined whether additional context data is detected. The context data may be obtained from additional external sources. The additional context data may be associated with different meanings of the gesture and stored in the gesture dictionary.

The dictionary indicates what information needs to be available from the additional sources, such as a tracking system, to override the default message and select one of the other messages associated with the gesture. The gesture interpretation queries a database that stores data from the tracking system to obtain information that may determine whether the interruption may be due to visitors, for example. Alternatively, the gesture interpretation unit may directly query the additional source of information.

As an additional source, for example, the tracking system records data about the locations of people within a building, and the gesture interpretation unit may query the tracking system to determine whether other people are located within the user's office. If so, the gesture interpretation unit may further determine whether the other people arrived recently in that location, for example with reference to the database. Thus, the gesture interpretation unit may output one of the alternative predefined messages.

The meaning of the gesture may be variable, and include a placeholder, in which names of people from the tracking system may be inserted. To determine what message should be sent, the gesture interpretation unit requests from the database names of people recently arrived, for example using WiFi tracking data. If the WiFi tracking database indicates that Tom and John had recently arrived in the user's office, the gesture handler may send out the message “Tom and John stopped by.” If the WiFi tracking database does not contain any names, but the camera tracking system, for example, indicates that one or more people recently arrived, the gesture interpretation unit may send out the message “Visitors stopped by.”

Accordingly, if the context data is detected in step 650, then the meaning of the gesture is determined with respect to the associated context data, in step 660.

If the context data is not detected in step 650, then the meaning of the gesture is determined based on only the detected gesture, in step 670.

In step 680, the determined meaning of the gesture is output. As discussed above, the meaning of the gesture may be output as text to a user through an application. Alternatively, the meaning of the gesture may be a command that causes an application to execute a process or function of the application.

As a result, the system and methods discussed above enable users to manage conversations, including negotiating between conversations, via gestures.

Although embodiments have been shown and described, it will be appreciated by those skilled in the art that changes may be made in these embodiments without departing from the principles and spirit of the inventive concept, the scope of which is defined in the appended claims and their equivalents.

1. A computer-readable medium having embodied thereon a program which, when executed by a computer, causes the computer to execute a method of processing a gesture, the method comprising:
detecting a gesture of a user;
determining a first message associated with the gesture and a first communication session, based on the gesture;
determining a second message associated with the gesture and a second communication session, based on the gesture; and
outputting the first message to the first communication session and outputting the second message to the second communication session.

2. The computer-readable medium according to claim 1, wherein the first communication session is a first electronic communication session between the user and a second user over a network and the second communication session is a second electronic communication session between the user and a third user over a network.

3. The computer-readable medium according to claim 2, wherein at least one of the first electronic communication session and the second electronic communication session is an instant messaging communication session.

4. The computer-readable medium according to claim 2, wherein the first electronic communication session is a communication session between the user and the second user through a first application program and the second electronic communication session is a communication session between the user and the third user through a second application program.

5. The computer-readable medium according to claim 1, wherein the method further comprises detecting an occurrence of an event,
wherein the determining the first message comprises determining the first message associated with the gesture and the first communication session based on the gesture and the occurrence of the event, and
wherein the determining the second message comprises determining the second message associated with the gesture and the second communication session based on the gesture and the occurrence of the event.

6. The computer-readable medium according to claim 5, wherein the occurrence of the event comprises at least one of detection of presence of a guest in the vicinity of the user and initiation of participation by the user in a new communication session.

7. The computer-readable medium according to claim 5, wherein the occurrence of the event comprises interruption of participation of the user in the first communication session and the second communication session.

8. The computer-readable medium according to claim 1, wherein the first communication session is a communication session between the user and a second user and the second communication session is a communication session between the user and a third user over a network,
wherein the method further comprises determining an identity of the second user and an identity of the third user,
wherein the determining of the first message comprises determining the first message associated with the gesture and the first communication session based on the gesture and the identity of the first user, and
wherein the determining of the second message comprises determining the second message associated with the gesture and the second communication session based on the gesture and the identity of the second user.

9. A computer-readable medium having embodied thereon a program which, when executed by a computer, causes the computer to execute a method of processing a gesture, the method comprising:
detecting a gesture of a user;
determining a first message associated with the gesture and a second user, based on the gesture;
determining a second message associated with the gesture and a third user, based on the gesture; and
outputting the first message to a first communication session between the user and the second user and outputting the second message to a second communication session between the user and the third user.

10. The computer-readable medium according to claim 9, wherein the first communication session is a first electronic communication session between the user and the second user over a network and the second communication session is a second electronic communication session between the user and a third user over a network.

11. The computer-readable medium according to claim 10, wherein at least one of the first electronic communication session and the second electronic communication session is an instant messaging communication session.

12. The computer-readable medium according to claim 10, wherein the first electronic communication session is a communication session between the user and the second user through a first application program and the second electronic communication session is a communication session between the user and the third user through a second application program.

13. A computer-readable medium having embodied thereon a program which, when executed by a computer, causes the computer to execute a method of processing a gesture, the method comprising:
defining, by a user, an unconventional gesture;
associating the unconventional gesture with a message;
detecting the unconventional gesture of the user; and
outputting the message associated with the unconventional gesture to a communication session between the user and a second user, in response to detecting the unconventional gesture.

14. The computer-readable medium according to claim 13, wherein the unconventional gesture is a gesture that is unassociated with nonverbal communication between the user and the second user.

15. The computer-readable medium according to claim 14, wherein the detecting comprises detecting the unconventional gesture of the user while the user participates in the communication session.

16. The computer-readable medium according to claim 13, wherein the unconventional gesture is a gesture that is not understood by the second user to convey a message between the user and the second user.

17. The computer-readable medium according to claim 16, wherein the detecting comprises detecting the gesture of the user while the user participates in the communication session.

18. The computer-readable medium according to claim 13, wherein the defining comprises:
recording the unconventional gesture of the user; and
storing the unconventional gesture of the user.

19. The computer-readable medium according to claim 18, wherein the storing comprises:
assigning at least one of movement and a position of a body part of the user as the unconventional gesture; and
storing coordinates representing the at least one of movement and the position of the body part of the user.

20. A computer-readable medium having embodied thereon a program which, when executed by a computer, causes the computer to execute a method of processing a gesture, the method comprising:
defining, by a user, an unconventional gesture;
associating the unconventional gesture with a command of an application that provides a communication session between the user and a second user, the command causing the application to perform a function of the application;
detecting the unconventional gesture of the user; and
outputting the command associated with the unconventional gesture to the application and performing the function of the application, in response to detecting the unconventional gesture.

21. The computer-readable recording medium according to claim 20, wherein the application is an instant messaging application and the command is a command to set a status of the user in the application.
